(19) United States
(12) Patent Application Publication
(10) Pub. No.: US 2007/0136081 A1
(43) Pub. Date: Jun. 14, 2007

(54) House enclosed in a structure and method of using and marketing the same

(75) Inventor: Justin R. Segal, Houston, TX (US)

Correspondence Address: LOCKE LIDDELL & SAPP LLP, 600 TRAVIS, 3400 CHASE TOWER, HOUSTON, TX, 77002-3095, US

(73) Assignee: CasAlegria, L.P.

(21) Appl. No.: 11/300,533

(22) Filed: Dec. 14, 2005

(51) Int. Cl. G06Q 99/00

(52) U.S. Cl. 705/1

(57) ABSTRACT

A freestanding house and a method of selling homes and other products and services relating to real estate and finance using this house that includes at least one bedroom, at least one bathroom, a plurality of walls, and a full roof, wherein the house is located within a structure. In a preferred embodiment, this house is located in a shopping mall and at least a portion of one wall is transparent. Moreover, methods of marketing customers, allowing for the selection construction upgrade options, and market testing are possible through the use of this house.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This disclosure relates generally to a housing display enclosed in a structure, and more particularly to a full-scale model home or similar structure being displayed in a structure including but not limited to shopping malls, convention centers, airports, bus or train stations, concert venues or arenas, large stores, or similar structures.

2. Description of the Related Art

Samples of construction and similar structures are known in the art. For example, it is known to include kiosks or similar structures in shopping malls and convention centers to provide a location for the display of merchandise, services, building materials, or information on homes for sale. These kiosks typically contain shelves or similar locations to display merchandise, samples, and information, and may include a means to secure this merchandise when the kiosk is not in operation. These may include graphical or pictorial representation of a home, a small-scale model of a home, or elements of a full-scale home, but do not include a complete, full-size home.

In addition, model homes are known to be constructed to show the craftsmanship of the builder and are usually located a place of prominence within a neighborhood. The model home allows visitors to that neighborhood to inspect the premises and visualize a fully furnished home while on the premises. These model homes require the purchaser to travel to the neighborhood and inspect the building on the premises.

In addition, model homes are known to be constructed outdoors, alone or in clusters, near a home builder's offices or design center, which may or may not be located near or in a neighborhood where new homes are available for purchase. Such model homes or clusters of model homes are not located in a structure and require the purchaser to travel to the location of the office or design center.

In addition, temporary, partial model homes are known to be built to show construction techniques, construction materials, or construction products intended for purchase or use by home builders. Such temporary installations, which typically showcase one or more specific products, are technical in nature, and are often in the context of a trade show for home builders, do not provide a method for potential home buyers to view and evaluate a home from the perspective of a home buyer.

Moreover, facades of homes have been built into storefronts to allow purchasers to review the options for home building in a shopping mall atmosphere. For example, a store employing certain home-like architectural or aesthetic elements has been constructed in storefront space abutting other retail stores that allows the purchaser to review options for inclusion in a home. Moreover, large stores that contain mockups of rooms are known that allow purchasers to view decoration and fixtures based on combinations that are provided in these mockups.

Potential customers do not have access to review a complete, freestanding home in these storefront or in-store settings while having the convenience of being within a structure such as a shopping mall. Therefore, a need exists to provide freestanding homes within a structure so that potential customers may inspect the home and weigh the option of purchasing a home of similar construction.

### BRIEF SUMMARY OF THE INVENTION

The present invention relates to a freestanding house and a method of selling homes using this house that includes at least one bedroom, at least one bathroom, a plurality of walls, and a full or partial roof, wherein the house is located within a structure. In a preferred embodiment, this house is located in a shopping mall and at least a portion of one wall is transparent.

The present invention also relates to methods of selling and providing products or services relating to real estate and real estate finance using this house.

The present invention also relates to methods of marketing to customers that enter the house or of soliciting information from customers that enter the house by providing a questionnaire to the customers and reviewing the answers to the questionnaire. This method may also include providing information to the customer regarding location and availability of homes after reviewing the answers to the questionnaire, adding the customer to a list for future contact, or directing the customer to an alternative housing source.

The present invention may also be used to allow for the selection of trim and feature options to a customer in a structure displaying a plurality of such options to the customer and allowing the customer to evaluate the options and select at least one option.

In an alternative embodiment, the present invention provides a method of qualifying customers by soliciting information from the customers that enter the house by providing a questionnaire and reviewing the answers to the questionnaire wherein the answers to the questionnaire indicate the creditworthiness of the customer and may lead to the offer or sale of financial products and services.

### BRIEF DESCRIPTION OF THE SEVERAL VIEWS OF THE DRAWINGS

FIG. 1 illustrates a perspective view of a house within a structure, preferably a shopping mall.

While the inventions disclosed herein are susceptible to various modifications and alternative forms, only a few specific embodiments have been shown by way of example in the drawings and are described in detail below. The figure and detailed description of these specific embodiments are not intended to limit the breadth or scope of the inventive concepts or the appended claims in any manner. Rather, the figure and detailed written descriptions are provided to illustrate the inventive concepts to a person of ordinary skill in the art and to enable such person to make and use the inventive concepts.

### DETAILED DESCRIPTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

The present invention relates to the provision of homes, or of products or services related to home buying, apartment location, home finance, credit repair, real estate finance, or home decoration or improvement by displaying a freestanding home constructed with the premises of a structure such as a shopping mall, convention center, large store, airport, bus or train station, arena, or similar structure. The home is constructed on the premises of the shopping mall such that purchasers may inspect the entire exterior of the home and enter the home and assess the interior construction of the home.

In a preferred embodiment, the home will be located in a high traffic location within the structure, such as an indoor atrium space or similar location that will attract potential customers to inspect the home.

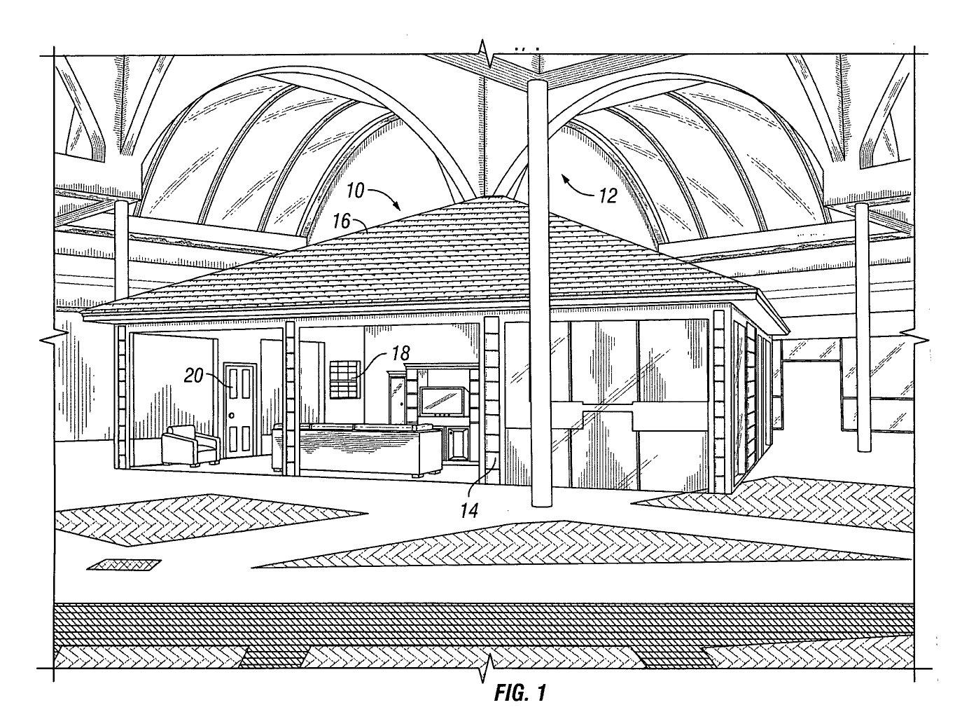

An example of the present invention is shown in FIG. 1. The house 10 is shown within a structure 12. The structure 12 herein is a shopping center. Those skilled in the art will recognize the advantage of placing the house 10 within a structure wherein a significant number of people are located. It is envisioned that a shopping mall is but one example of a structure wherein people traffic. Other examples of preferable structures are convention centers, airports, bus or train stations, concert venues or arenas, large stores, or similar structures. The house 10 is shown with a plurality of exterior walls 14 and a full roof 16. Moreover, at least one window 18 and at least one door 20 are shown herein.

In order to provide for easier inspection and to capture the attention of mall customers, it is envisioned that at least one exterior wall 14 of the home will be made of a transparent material, such as glass or Plexi-Glas™ materials, in a most preferred embodiment. For ease of viewing inside the house, it is preferable to limit the number of interior doors, but it is advantageous to display doors for some rooms or closets, such as the linen closet or the pantry. It is envisioned that some of these people will view the house 10 and enter the house 10 in order to view the interior in greater detail.

In a most preferred embodiment, the home is approximately 1400 square feet and is constructed as a one-story dwelling. It is envisioned that the dwelling can be from about 900 square feet to about 3000 square feet. This home should include at least one bedroom and preferably will include a plurality of bedrooms to better accommodate purchasers with families or the need for additional bedrooms. Moreover, the home may include at least one of the following rooms: a bathroom, a nursery, a laundry room, a kitchen, a living room, or a combination thereof.

In a preferred embodiment, the house is constructed with a full roof 16 to display the roofline and to provide for full inspection of the quality of the roof build. In an alternative embodiment, at least a portion of this roof 16 may also be transparent to allow for the inspection of the construction of the attic and to display the methods of insulating the home.

In an alternative embodiment, the roof may be only partially completed in order to comply with building and/or fire codes, or to accommodate ceiling heights, lines of sight, or the practicalities of construction in a particular physical location.

In an alternative embodiment, it is envisioned that the electrical components of the home such as lighting fixtures and electrical outlets will be functional and wired to a central location, such as a central console. In a preferred embodiment, this central console is located a closet that is not accessible to visitors. The plumbing and the fixtures are typically not connected to water and sewage connections, but it is envisioned that these connections are within the scope of the invention.

The home may display several different levels of feature and trim options. It is envisioned that the home may include examples of upgrade options to allow the customer to assess the inclusion of these options in the home that he or she purchases. In a preferred embodiment, some of the premium options will be displayed to allow the customer to evaluate the full range of options available. The visual appearance of the exterior and the interior is designed to entice potential customers to interact with the home and contribute to the visual appearance of the mall in general.

In a preferred embodiment, the home will include additional amenities such as electronics and appliances. The electronics should include televisions, entertainment systems, game systems, speakers, and similar products. The appliances displayed should include kitchen appliances that complement the functionality and appearance of the home.

In operation, the home may be staffed by a salesperson that is capable of collecting customer information, providing information about the home and its construction, and providing information about the location and availability of homes like the present invention. The salesperson may determine through qualifying questions that a potential customer should be added to a list for future contact or directed to an alternate housing source, such as a broker or mortgage broker, for immediate assistance. It is envisioned that the salesperson may also be able to offer financial products related to home finance.

The salesperson may also engage in market testing. It is expected that the salesperson will request that potential customers complete questionnaires, presented either as part of the normal application process or as an explicit marketing questionnaire. The questionnaire may include questions that assess the credit, creditworthiness, income level, employment status, demographics, age, ethnicity, family size, family position, residency status, and similar information about the potential customer. In a preferred method, the salesperson will also determine the potential customer's current status, including the current housing location, the current housing type, and similar information. The salesperson will attempt to determine the potential customer's preference in design, aesthetic preferences in finishes, configuration preferences, number of bedrooms and bathrooms required, and similar information. The salesperson will preferably determine the current residence, the work location, acceptable commute time and distance, and importance of school district, municipality, and similar information of the potential customer.

The present invention may also be an outlet to provide financing products. It is envisioned that the present invention may provide an opportunity to act as a broker or mortgage banker to obtain or originate financing for the purchase of homes. Additionally, the present invention may utilize naming to establish and enhance its branding. As with automobiles, the branding of the house and the development company will play an important role in the perception of the product.

Another advantage of the present invention is marketing. The use of the present invention will reduce marketing costs by placing the product in a location already trafficked by customers, rather than having to entice customers to travel to the location of the product. By allowing walk-in and look-in tours, barriers-to-purchase will be significantly lower than with existing methods of selling real estate and related products and services. The present invention can be used for a variety of purposes. Such uses include sale of houses built by the owner of the model home, sale of houses built by other builders, sale of existing houses, sale of developed lots, home-buyer education, brokering of mortgage finance, origination of mortgage finance, rental space for residential broker, rental space for mortgage broker, rental space for apartment locator, rental space for events such as a cocktail party, Tupperware® party, Mary Kay® sales party, rental space for vendors/product display & demonstration such as appliance company, carpet cleaner/vacuum sales, Corian™ counter tops, paint company, sponsored display site, furniture by Rooms to Go, technology by Samsung, market research, and lead generation for a variety of third-party vendors such as mortgage broker, residential broker, furniture store, technology, furniture-rentals, and similar uses.

It is preferable to staff the present invention with employees to work in the present during regular retail hours.

It is envisioned that partners will be used to provide additional services and augment services not being provided by the owner of the present invention. Possible partners include residential brokers, land developers, apartment locators or apartment complexes, mortgage brokers, furniture companies, home builders, credit counselors, and other similar partners.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect all such modifications and improvements to the full extent that such falls within the scope or range of equivalent of the following claims.

What is claimed is:

1. A freestanding house comprising:
at least one bedroom;
at least one bathroom;
a plurality of walls;
a full roof;
wherein the house is located within a structure.

2. The house of claim 1 wherein the structure is a shopping mall.

3. The house of claim 1 wherein at least a portion of one wall is transparent.

4. The house of claim 1 further comprising a living room wherein the living room is larger than at least one bedroom.

5. A method of marketing to customers at a structure comprising the steps of:
providing the house of claim 1 within the structure;
soliciting information to customers that enter the house by providing a questionnaire to the customers;
reviewing the answers to the questionnaire; and
providing information to the customer regarding location and availability of homes.

6. The method of claim 5 further comprising adding the customer to a list for future contact.

7. The method of claim 5 further comprising directing the customer to an alternative or related housing source.

8. The method of claim 5 further comprising offering at least one financial product or service to the customer.

9. A method of selection of feature and trim upgrade options to a customer in a structure comprising the steps of:
providing the house of claim 1 within the structure;
displaying a plurality of construction upgrade options to the customer;
allowing the customer to evaluate the options and select at least one option.

10. A method of qualifying customers at a structure comprising the steps of:
providing the house of claim 1 within the structure;
soliciting information from the customers that enter the house by providing a questionnaire; and
reviewing the answers to the questionnaire;
wherein the answers to the questionnaire indicate the creditworthiness of the customer or the interest of customer in a range of real estate and finance related products and services.

11. The method of claim 10 wherein the answers to the questionnaire indicate the customer's preference in design.

12. A method of selling at least one home comprising:
providing the house of claim 1 within the structure;
attracting at least one customer into the house;
offering the home for sale after the customer has viewed the house.

13. The method of claim 12 wherein the structure is a shopping mall.

14. The method of claim 12 wherein at least a portion of one wall is transparent.
